(19) United States
(12) Patent Application Publication
(10) Pub. No.: US 2019/0385779 A1
(43) Pub. Date: Dec. 19, 2019

(54) COIL COMPONENT CORE AND COIL COMPONENT

(71) Applicant: SUMIDA CORPORATION, Tokyo (JP)

(72) Inventor: Mitsugu KAWARAI, Natori City (JP)

(21) Appl. No.: 16/557,173

(22) Filed: Aug. 30, 2019

Related U.S. Application Data
(63) Continuation of application No. PCT/JP2018/000638, filed on Jan. 12, 2018.

(30) Foreign Application Priority Data
Apr. 7, 2017 (JP) 2017-077133

(51) Int. Cl. H01F 27/24; H01F 27/28; H01F 27/29

(52) U.S. Cl. CPC H01F 27/24; H01F 27/29; H01F 27/2823

(57) ABSTRACT

A coil component core is configured by having a plurality of core pieces that are connected in an annular shape. With respect to each of the plurality of core pierces, when a length in a magnetic path direction is I and a cross-sectional area that is perpendicular to the magnetic path direction is S, I/S is equal to or less than 1.0. The number of the core pierces is equal to or more than 8, and I is equal to or less than 30% of a magnetic path length of the coil component core.

### CROSS-REFERENCE TO RELATED APPLICATIONS

This application is a continuation of PCT/JP2018/000638 filed Jan. 12, 2018. This application claims the benefit of Japanese Patent Application No. 2017-077133 filed Apr. 7, 2017. The entire disclosures of the above applications are incorporated herein by reference.

### BACKGROUND

### 1. Technical Field

The present invention relates to a coil component core (a core for a coil component) and a coil component.

### 2. Related Art

In Japanese Patent Publication Number H09-7855, a coil component that has an annular core and a coil wound around the core is described.

There is a case in which a gap is provided in a core so as to adjust an L value of a coil component and improve a direct current (DC) superimposition (superimposed) characteristic. Though the improvement of the DC superimposition characteristic is realized by decreasing an effective relative magnetic permeability of the core by enlarging the gap, it is necessary to increase the number of turns of the coil to obtain a sufficient L value for the core in which the effective relative magnetic permeability decreases. However, because increasing the number of turns of the coil will lead to an increase of the direct current (DC) resistance of the coil, a decrease of an allowable current due to the heat generation, and an increase of loss, it is not preferred for securing a satisfactory characteristic of the coil component. Therefore, the improvement of the DC superimposition characteristic needs to be accomplished by means of a technique other than a method of decreasing the effective relative magnetic permeability of a core.

### SUMMARY

The present invention attempts to solve the above problems. An object of the present invention is to provide a coil component core (a core of a coil component) and a coil component that have configurations that improve a DC superimposition characteristic by means of a technique other than a method of decreasing an effective relative magnetic permeability of a core.

In order to achieve the above object, a coil component core is configured by having a plurality of core pieces that are connected in an annular (ring) shape. With respect to each of the plurality of core pierces, when a length in a magnetic path direction is I and a cross-sectional area that is perpendicular to the magnetic path direction is S, I/S is equal to or less than 1.0.

Further, according to the present invention, a core component has the coil component core of the present invention and a coil that is wound around the coil component core.

According to the present invention, it is possible to improve a DC superimposition characteristic of a coil component core by means of a technique other than a method of decreasing an effective relative magnetic permeability of the coil component core.

### BRIEF DESCRIPTION OF THE DRAWINGS

FIG. 1A is a schematic plan view that shows a coil component core according to a first embodiment. FIG. 1B a schematic perspective view that shows the coil component core according to the first embodiment. FIG. 1C is a schematic plan view that shows one core piece that configures the coil component core according to the first embodiment.

FIG. 2 is a schematic plan view that shows a coil component according to the first embodiment.

FIG. 3 is a schematic plan view that shows a coil component core according to a second embodiment.

FIG. 4 is a diagram that shows parameters of coil component cores according to embodiments and comparative examples.

FIG. 5 is a diagram that shows characteristics of the coil component cores according to the embodiments and the comparative examples.

FIGS. 6A, 6B, 6C, 6D, 6E, 6F, 6G, 6H, and 6I are diagrams that show planar shapes of the coil component cores according to the embodiments and the comparative examples.

FIG. 7 is a graph that shows characteristics of the coil component cores according to the embodiments and the comparative examples.

FIG. 8 is a diagram that shows characteristics of the coil component cores according to the embodiments and the comparative examples.

FIGS. 9A, 9B, 9C, 9D, 9E, 9F, 9G, 9H, 9I, and 9J are diagrams that show planar shapes of the coil component cores according to the embodiments and comparative examples.

FIG. 10 is a graph that shows characteristics of the coil component cores according to the embodiments and comparative examples.

FIG. 11 is a diagram that shows characteristics of the coil component cores according to the embodiments and comparative examples.

FIG. 12 is a diagram that shows characteristics of the coil component cores according to the embodiments and comparative examples.

FIGS. 13A, 13B, 13C, 13D, 13E, 13F, 13G, and 13H are diagrams that show planar shapes of the coil component cores according to the embodiments and comparative examples.

FIG. 14 is a graph that shows characteristics of the coil component cores according to the embodiments and comparative examples.

FIG. 15 is a graph that shows characteristics of the coil component cores according to the embodiments and comparative examples.

### DESCRIPTION OF EXEMPLARY EMBODIMENTS

As discussed below, embodiments according to the present invention are explained with reference to the drawings. In regards to the drawings, redundant explanations with respect to the same configurations are omitted but the same reference numerals are used for labeling.

### First Embodiment

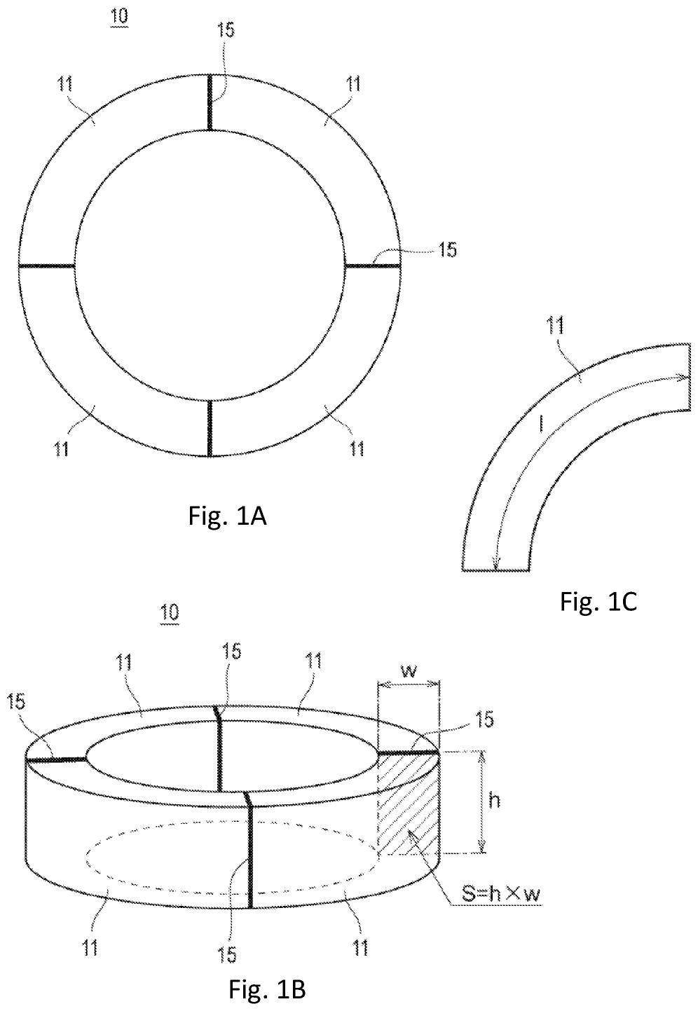

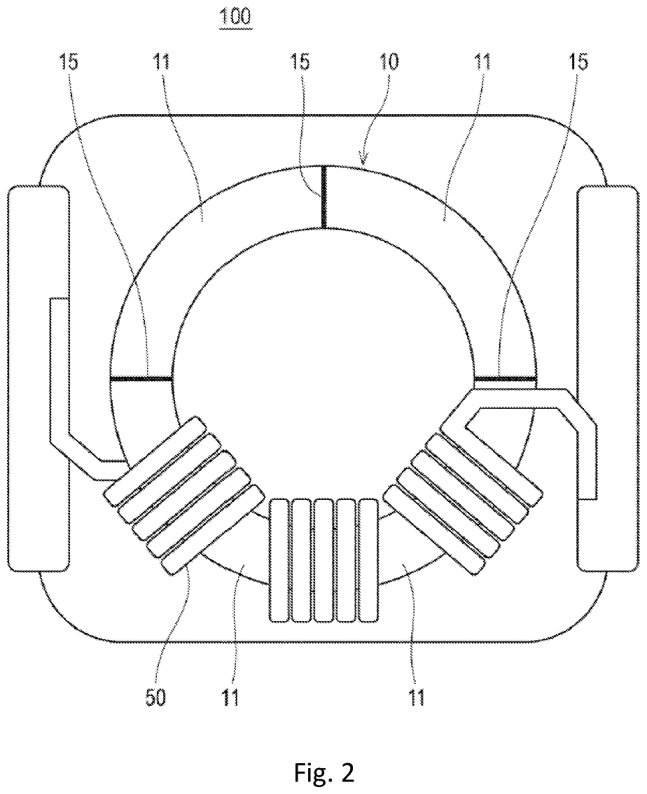

First of all, a first embodiment will be explained with reference to FIGS. 1A-1C and 2. With respect to a coil component 100 (FIG. 2) that is configured by having a coil component core 10 (FIGS. 1A and 1B) that is configured with split cores (a plurality of core pieces 11), a direct current (DC) superimposition characteristic is improved by concentrating a magnetic field to a non-magnetic gap 15 (a magnetic gap) that is not magnetically saturated. In order to further improve the DC superimposition characteristic of the coil component 100 explained above, the inventor of the present application focused and examined about a difference of a magnetic resistance according to a shape of the split core. As a result of the examinations, the inventor of the present application considered that when the magnetic resistance of the split core decreases, the magnetic field is further concentrated to the non-magnetic gap 15 so that the DC superimposition characteristic is improved. When a length of a core piece 11 in a magnetic path direction is defined to “I” and a cross-sectional area of the core piece 11 orthogonal to the magnetic path direction is defined to “S,” a magnetic resistance “Rm” of the core piece 11 is represented by:

Rm=(I/S)/μ

The relative permeability “μ” is defined by a material that configures the core piece 11. Because the material of the core piece 11 is selected so as to satisfy a request value of a saturation magnetic flux density and a frequency characteristic, the material that needlessly has a high p value cannot be selected. Therefore, the inventor of the present application considered that it is preferred to focus on the value of the I/S that is defined by the shape of the core piece 11 as means of a technique for decreasing the magnetic resistance “Rm” of the core piece 11. As a result of the earnest investigations by the inventor of the present application regarding a preferred range of the value of I/S, it was newly discovered that the DC superimposition characteristic of the coil component core 10 can be remarkably improved since the I/S is equal to or less than 1.0.

In other words, as shown in FIGS. 1A and 1B, the coil component core 10 according to the present embodiment is configured with a plurality of core pieces 11 that are arranged to be connected in an annular (ring) shape. With respect to each of the plurality of core pieces 11 of this coil component core 10, when a length in a magnetic path direction is defined as “I” (refer to FIG. 1C) and a cross-sectional area orthogonal to the magnetic path direction is defined as “S” (refer to FIG. 1B), I/S is equal to or less than 1.0. In other words, with respect to each of all the core pieces 11 that configure the coil component core 10, the length I and the cross-sectional area S are set so that the I/S is equal to or less than 1.0. Further, when the cross-sectional area S is changed according to a position of the core piece 11 in a longitudinal direction, the cross-sectional area S can be a mean value of the cross-sectional areas S of each part of the core piece 11 in the longitudinal direction. The non-magnetic gap 15 is respectively formed between the core pieces 11 that are adjacent to each other in the magnetic path direction. As a result, the coil component core 10 has the plurality of non-magnetic gaps 15. A size of each of the non-magnetic gaps 15 (a gap dimension) can be, for instance, equal to each other. However, the non-magnetic gap 15 in which the gap dimension is different from the others can be included among the plurality of non-magnetic gaps 15. Each of the core pieces 11 is composed of a magnetic material.

According to the configuration of the coil component core 10 explained above, the DC superimposition characteristic of the coil component core 10 can be significantly improved without changing an effective relative magnetic permeability of the coil component core 10.

Further, it is also preferred that the I/S of each of the plurality of core pieces 11 that configures the coil component core 10 is equal to or less than 0.8. As a result, the DC superimposition characteristic of the coil component core 10 can be further improved.

Further, it is also preferred that the I/S of each of the plurality of core pieces 11 that configures the coil component core 10 is equal to or less than 0.65. As a result, the DC superimposition characteristic of the coil component core 10 can be further improved.

Further, it is also preferred that the I/S of each of the plurality of core pieces 11 that configures the coil component core 10 is equal to or less than 0.5. As a result, the DC superimposition characteristic of the coil component core 10 can be further improved.

Further, it is also preferred that the I/S of each of the plurality of core pieces 11 that configures the coil component core 10 is equal to or less than 0.4. As a result, the DC superimposition characteristic of the coil component core 10 can be further improved.

Further, an example, in which the coil component core 10 has four core pieces 11, is shown in FIGS. 1A and 1. However, the number of the core pieces 11 that the coil component core 10 has can be any number of two or more. Further, an example, in which each of the core pieces 11 that the coil component core 10 has is in the same shape (the same size) as each other, is shown in FIGS. 1A and 1B. However, the core piece 11, in which the shape (for instance, the length I (FIG. 1C) in the magnetic path direction) is different from each other, may also be contained among the plurality of core pieces 11 of the coil component core 10. Further, an example, in which the coil component core 10 is in the annular shape, is shown in FIG. 1A. However, the shape of the coil component core 10 may also be in other annular (ring) shapes. In other words, the shape of the coil component core 10 may also be, for instance, in an ellipse (oval) annular (ring) shape or a polygonal annular (ring) shape (such as a rectangular annular (ring) shape). Further, an example, in which the cross-sectional shapes of each of the core pieces 11 and the coil component core 10 is in a rectangular shape, is shown in FIG. 1B. However, the present invention is not limited to this example. For instance, the cross-sectional shapes of each of the core pieces 11 and the coil component core 10 may also be in a circular shape, an ellipse (oval) shape, or a polygonal shape other than the rectangular shape.

As shown in FIG. 2, the coil component 100 according to the present embodiment is configured with the coil component core 10 according to the present embodiment and a coil 50 that is wound around the coil component core 10. The coil component 100 is, for instance, an inductor.

According to the first embodiment explained above, with respect to each of the plurality of core pieces 11 that configures the coil component core 10, since the I/S is equal to or less than 1.0, the DC superimposition characteristic of the coil component core 10 can be significantly improved without changing the effective relative magnetic permeability of the coil component core 10.

### Second Embodiment

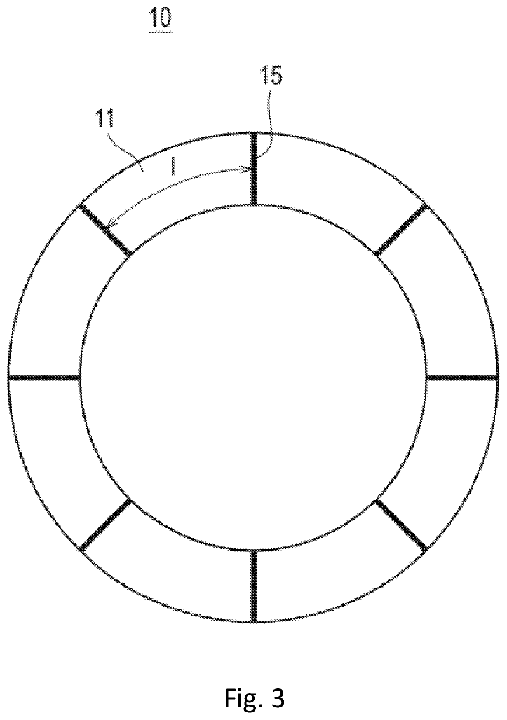

Next, a second embodiment will be explained with reference to FIG. 3. As compared with the coil component core 10 according to the first embodiment explained above, a coil component core 10 according to the present embodiment is further characterized by matters that will be explained below. With respect to the other matters, the coil component core 10 according to the present embodiment is configured in the same way as the coil component core 10 according to the first embodiment explained above. Further, a coil component (not shown) according to the present embodiment is configured with the coil component core 10 according to the present embodiment and a coil (not shown) that is wound around the coil component core 10.

As a result of the further earnest investigation by the inventor of the present application regarding shapes of the plurality of core pieces 11 that configures the coil component core 10, it was discovered that the DC superimposition characteristic can be further suitably improved when the number of the plurality of core pieces 11 that configures the coil component core 10 is eight or more.

In other words, with respect to the coil component core 10 according to the present embodiment, the number of the core pieces 11 that configure the coil component core 10 is eight or more.

Further, it is also preferred that the number of the core pieces 11 that configure the coil component core 10 is ten or more. As a result, the DC superimposition characteristic of the coil component core 10 can be further improved.

Further, as a result of the further earnest investigation by the inventor of the present application regarding shapes of the plurality of core pieces 11 that configures the coil component core 10, it was discovered that the DC superimposition characteristic can be further suitably improved when the length “I” that is the largest among the plurality of core pieces 11 that configures the coil component core 10 is equal to or less than 25% of a length of a magnetic path of the coil component core 10.

In other words, with respect to the coil component core 10 according to the present embodiment, it is preferred that the length “I” of each of the plurality of core pieces 11 is equal to or less than 25% of the length of the magnetic path.

Further, it is also preferred that the length “I” of each of the plurality of core pieces 11 is equal to or less than 20% of the length of the magnetic path. As a result, the DC superimposition characteristic of the coil component core 10 can be further improved.

Further, it is also preferred that the length “I” of each of the plurality of core pieces 11 is equal to or less than 15% of the length of the magnetic path. As a result, the DC superimposition characteristic of the coil component core 10 can be further improved.

Further, as a result of the further earnest investigation by the inventor of the present application regarding shapes of the plurality of core pieces 11 that configures the coil component core 10 when the number of the core pieces 11 that configure the coil component core 10 is eight or more, it was discovered that the DC superimposition characteristic can be further suitably improved when the length “I” that is the largest among the plurality of core pieces 11 that configures the coil component core 10 is equal to or less than 30% of the length of the magnetic path of the coil component core 10.

In other words, it is preferred that the length “I” of each of the plurality of core pieces 11 is equal to or less than 30% of the length of the magnetic path when the number of the core pieces that configure the coil component core 10 is eight or more. As a result, the DC superimposition characteristic of the coil component core 10 can be excellently improved.

In the example shown in FIG. 3, the number of the core pieces 11 that configure the coil component core 10 is eight and each of the core pieces 11 is formed to be mutually in the same shape. Therefore, in the example shown in FIG. 3, the length “I” of each of the core pieces 11 is 12.5% of the length of the magnetic path. In other words, with respect to the coil component core 10 shown in FIG. 3, the number of the core pieces 11 that configure the coil component core 10 is eight or more. At the same time, the length “I” that is the largest among the plurality of core pieces 11 that configures the coil component core 10 is equal to or less than 15% of the length of the magnetic path of the coil component core 10.

According the second embodiment explained above, since the number of the core pieces 11 that configure the coil component core 10 is eight or more, the DC superimposition characteristic can be further properly improved. Further, since the length “I” of each of the plurality of core pieces 11 that configures the coil component core 10 is equal to or less than 25% of the length of the magnetic path, the DC superimposition characteristic can be further properly improved. Further, when the number of the core pieces that configure the coil component core 10 is eight or more, even if the length “I” of each of the plurality of core pieces 11 that configures the coil component core 10 is equal to or less than 30% of the length of the magnetic path, the DC superimposition characteristic can also be excellently improved.

### EMBODIMENTS

Each of embodiments and comparative examples will be explained below.

### Embodiments 1-20 and Comparative Examples 1-7

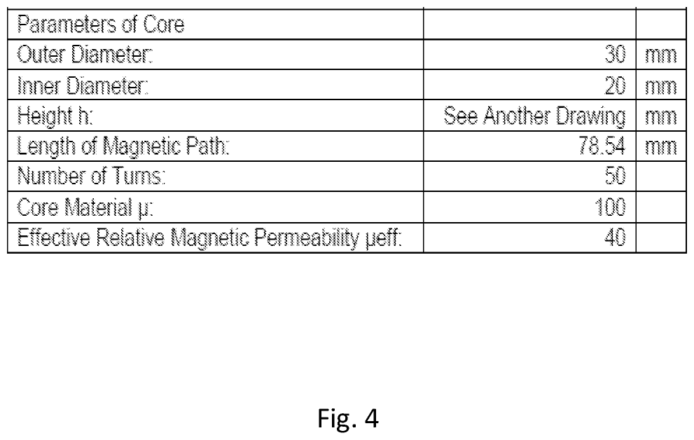

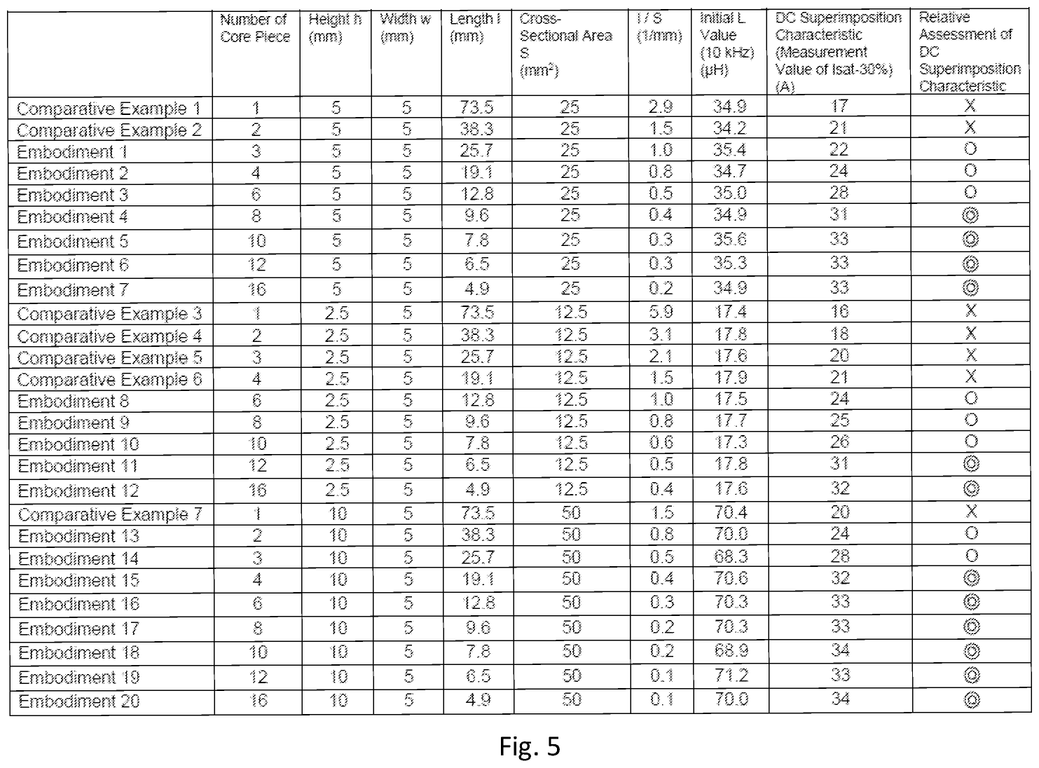

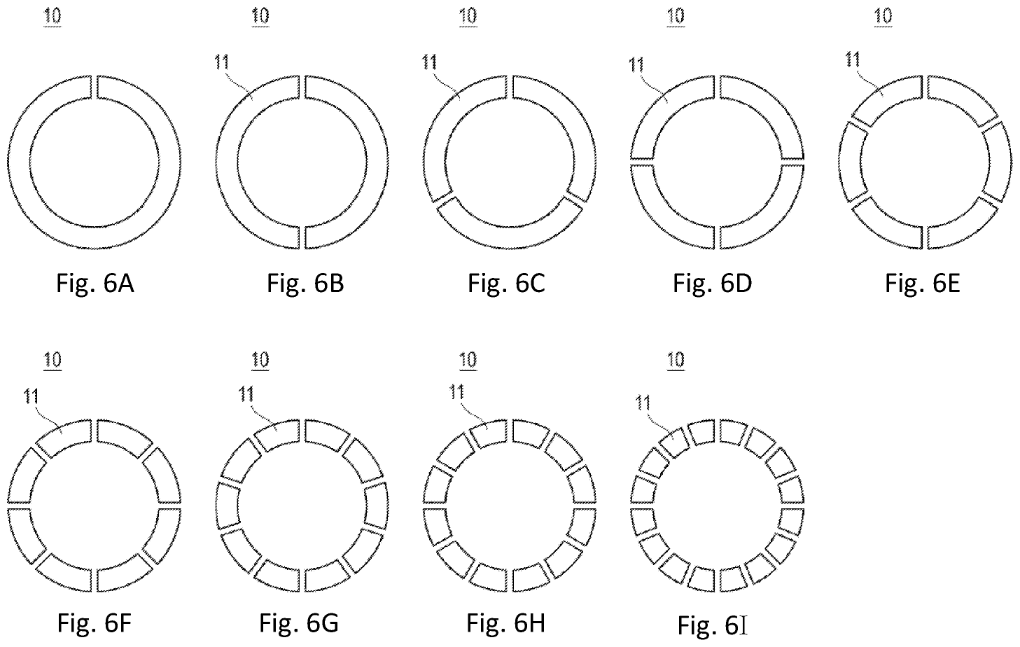

First of all, the embodiments 1-20 and the comparative examples 1-7 will be explained with reference to FIGS. 4-7. Parameters of a coil component core that is utilized in each of the embodiments 1-20 and each of the comparative examples 1-7 are shown in FIG. 4. An annular shape is utilized as the coil component core. As shown in FIG. 4, because the outer diameter is 30 mm and the inner diameter is 20 mm, a width W shown in FIG. 1B is 10/2=5 mm. Further, as shown in FIG. 5, with respect to each of the embodiments 1-20 and each of the comparative examples 1-7, the height (a thickness) h shown in FIG. 1B is set to be any of three kinds, 5 mm, 2.5 mm, and 10 mm. As shown in FIG. 4, with respect to each of the embodiments 1-20 and each of the comparative examples 1-7, a metal-based sintered core material, in which a relative permeability p is 100, is utilized as a core material that composes each of the core pieces of the coil component core. With respect to each of the three kinds of the heights h, nine kinds of coil component cores, in which the numbers of core pieces are one (FIG. 6A), two (FIG. 6B), three (FIG. 6C), four (FIG. 6D), six (FIG. 6E), eight (FIG. 6F), ten (FIG. 6G), twelve (FIG. 6H), and sixteen (FIG. 6I), were prepared. Among them, as shown in FIG. 6A, when the number of core pieces is one, the core piece (in this case, the core piece corresponds to the coil component core) is annular C-shaped. Further, when the number of the core pieces is two or more, as respectively shown in FIGS. 6B, 6C, 6D, 6E, 6F, 6G, 6H, and 6I, each of the core pieces is arc-shaped and the lengths “I” of each of the core pieces are equal to each other. With respect to the coil component cores in which the number of the core pieces is two or more, the non-magnetic gaps that are the same numbers of the core pieces are arranged at equal intervals (distances). Further, with respect to each of the coil component cores, the sizes of the gap dimensions of the plurality of non-magnetic gaps are the same (a constant). Further, the gap dimension of each of the non-magnetic gaps is adjusted so as to make the effective relative magnetic permeability to be 40. A coil is provided by winding a coated lead wire in which a wire diameter is 0.9 mm around the coil component core at 50 times so as to configure the coil component. In addition, the coil component is inserted into a case in which two external electrodes are formed and two terminals of the coil are respectively soldered to the external electrodes so as to manufacture an inductor. Since the effective relative magnetic permeability of the coil component cores is adjusted to be 40, as shown in FIG. 5, with respect to the coil component cores in which the heights h are the same as each other, initial inductance values (initial L values) are supposed to become the same at any of the inductors. However, in the embodiments and examples, because the coil component cores 10 having the same height have the different numbers of core pieces 11 (the different numbers of the non-magnetic gaps 15), the actual initial L value (initial inductance values) of some of the coil component cores 10 having the same height are slightly different. Further, as the measurement of the initial L value, the inductance values were measured by connecting BIAS CURRENT TEST FIXTURE 42842B (referred to as “a second measuring device” below) manufactured by Agilent Technologies, Inc. to Precision LCR Meter E4980A (referred to as “a first measuring device” below) manufactured by Agilent Technologies, Inc. without applying a DC bias current.

With respect to each of the embodiments 1-20 and each of the comparative examples 1-7, the length “I” of the core piece, the cross-sectional area “S,” the value of I/S, the initial L value at 10 kHz, the measured value of the DC superimposition characteristic, and the relative assessment of the DC superimposition characteristic are respectively shown in FIG. 5. Here, the DC superimposition characteristic corresponds to a value of the direct current when the L value is decreased by 30% as compared with the initial value (the measured value of Isat−30%). It can be judged that the higher this value is, the more the inductance value can be held to a large current (in other words, the performance is excellent). Further, with respect to the measurement of the DC superimposition characteristic, the inductance value was measured by connecting the second measuring device explained above to the first measuring device explained above, and in addition, by connecting BIAS CURRENT SOURCE 42841A manufactured by Agilent Technologies, Inc. to the second measuring device with the application of the DC bias current. At this time, the measurement was performed while the DC bias current is raised by 0.5 A at each time from OA until the inductance value is decreased from the initial L value by 30%. The DC superimposition characteristic (the measured value of Isat−30%) is measured by plotting the measured inductance values in a graph and by reading the current value at the point in which the inductance value becomes “−30%” of the initial L value from the graph. Further, with respect to the relative assessment of the DC superimposition characteristic, “⊚” (double circles) denotes that the assessment is extremely satisfactory, “◯” (single circle) denotes that the assessment is satisfactory, and “x” denotes others. As shown in FIG. 5, with respect to each of the embodiments 1-20, i.e., they have the value of I/S that is equal to or less than 1.0, all of them could obtain the satisfactory DC superimposition characteristic. As a result, the relative assessments of the DC superimposition characteristics are “⊚” (the double circles) or “◯” (the single circle). In particular, with respect to each of the embodiments 4-7, 11, 12, and 15-20, i.e., they have a value of I/S that is equal to or less than 0.4, all of them could obtain the extremely satisfactory DC superimposition characteristic. As a result, the relative assessments of the DC superimposition characteristics are “⊚” (the double circles). Further, it is understood that it is preferred that the number of the core pieces that configure the coil component core is three or more, it is more preferred that the same is six or more, it is further preferred that the same is eight or more, and it is furthermore preferred that the same is ten or more.

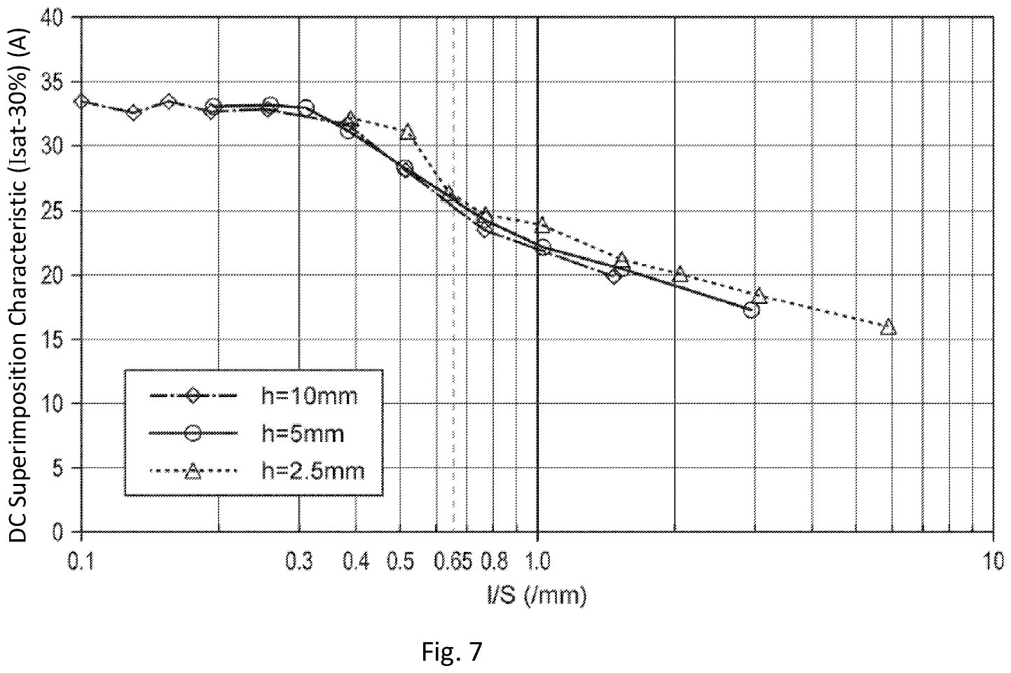

FIG. 7 is a graph that shows plotting of the DC superimposition characteristics of nine kinds of the coil component cores with respect to each of three kinds of the heights “h.” In FIG. 7, the horizontal axis corresponds to I/S and the vertical axis corresponds to the DC superimposition characteristics. According to FIG. 7, it is also understood that the satisfactory DC superimposition characteristics can be obtained when the value of I/S is equal to or less than 1.0. Further, more satisfactory DC superimposition characteristics can be obtained when the value of I/S is equal to or less than 0.8. Further satisfactory DC superimposition characteristics can be obtained when the value of I/S is equal to or less than 0.65. Furthermore satisfactory DC superimposition characteristics can be obtained when the value of I/S is equal to or less than 0.5. Extremely satisfactory DC superimposition characteristics can be obtained when the value of I/S is equal to or less than 0.4. Further, it is understood that the DC superimposition characteristic tends to saturate when the value of I/S is approximately equal to or less than 0.3. In other words, it is specifically preferred that the value of I/S is equal to or less than 0.3. Further, the values of the DC superimposition characteristics shown in FIG. 5 are obtained by rounding off beyond the first decimal place. FIG. 7 is the graph that shows the plotting of the values before rounding off.

### Embodiments 21-28 and Comparative Examples 8 and 9

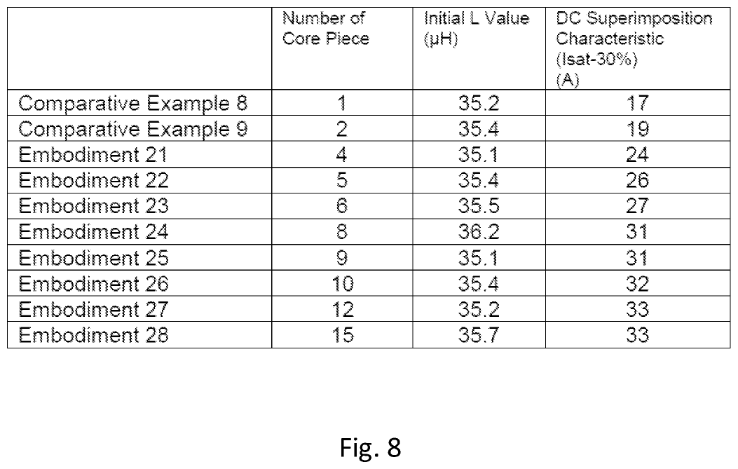

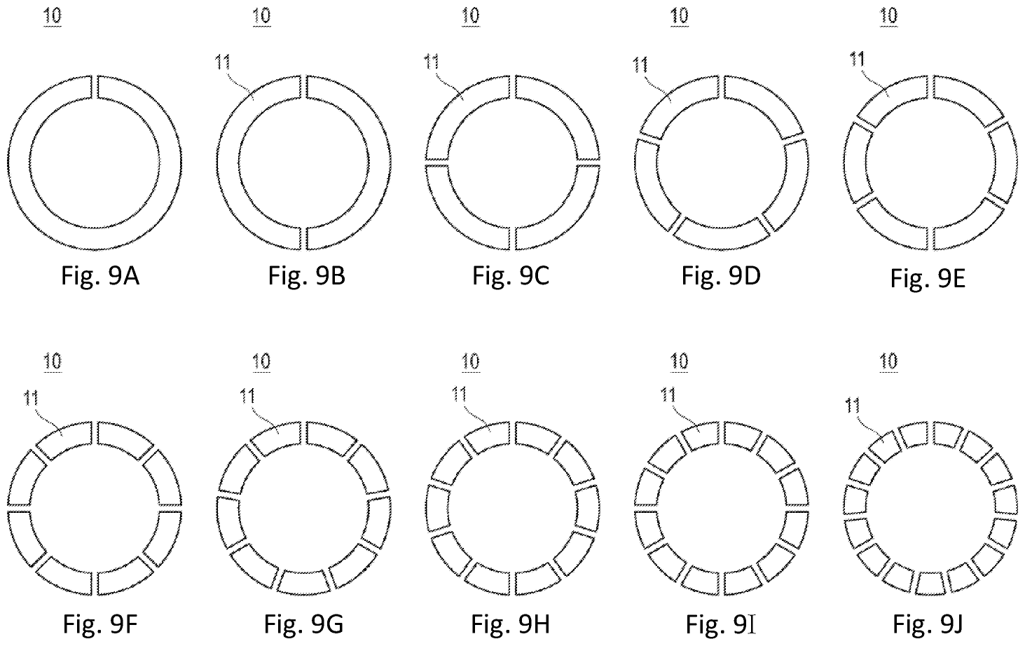

Next, embodiments 21-28 and comparative examples 8 and 9 will be explained with reference to FIGS. 8-10. In these embodiments and examples, the annular shape is also utilized for each of the coil component cores. In these embodiments and examples, the parameters of the coil component cores are also shown in FIG. 4. However, all of the heights (the thicknesses) h are 5 mm. As shown in FIGS. 8-9J, ten kinds of coil component cores, in which the numbers of core pieces are one (FIG. 9A: the comparative example 8), two (FIG. 9B: the comparative example 9), four (FIG. 9C: the embodiment 21), five (FIG. 9D: the embodiment 22), six (FIG. 9E: the embodiment 23), eight (FIG. 9F: the embodiment 24), nine (FIG. 9G: the embodiment 25), ten (FIG. 9H: the embodiment 26), twelve (FIG. 9I: the embodiment 27), and fifteen (FIG. 9J: the embodiment 28), were prepared. Among them, as shown in FIG. 9A, when the number of the core pieces is one, the core piece (in this case, the core piece corresponds to the coil component core) is annular C-shaped. Further, when the number of the core pieces is two or more, as respectively shown in FIGS. 9B, 9C, 9D, 9E, 9F, 9G, 9H, 9I, and 9J, each of the core pieces is arc-shaped and the lengths “I” of each of the core pieces are equal. With respect to the coil component cores in which the number of the core pieces is two or more, the non-magnetic gaps that are the same numbers of the core pieces are arranged at equal intervals (distances). Further, with respect to each of the coil component cores, the sizes of the gap dimensions of the plurality of non-magnetic gaps are the same. In these embodiments and examples, the coil is also provided by winding a coated lead wire in which a wire diameter is 0.9 mm around the coil component core at 50 times so as to configure the coil component. In addition, the coil component is inserted into a case in which two external electrodes are formed and two terminals of the coil are respectively soldered to the external electrodes so as to manufacture the inductor. Since the effective relative magnetic permeability of the coil component cores is adjusted to be 40, as shown in FIG. 8, and their heights are the same (5 mm), the initial inductance values (initial L values) are supposed to become the same at any of the inductors. However, in the embodiments and examples, because the coil component cores 10 having the same height (5 mm) have the different numbers of core pieces 11 (the different numbers of the non-magnetic gaps 15), the actual initial L value (initial inductance values) of some of the coil component cores 10 having the same height are slightly different. In addition, since all of the number of turns of the wire that configures the coils are the same (the 50 times), the DC resistance values of each inductor become the same. Further, the measurements of the initial L values are performed in the same manner as the embodiments 1-20 and the comparative examples 1-7.

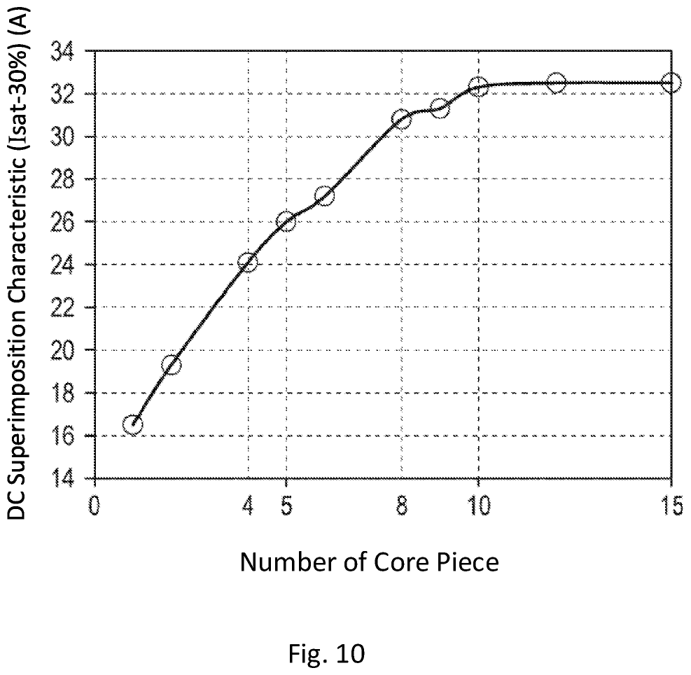

The measurement values of the DC superimposition characteristics are shown in FIG. 8 with respect to the embodiments 21-28 and the comparative examples 8 and 9. In these embodiments and examples, the DC superimposition characteristics also correspond to the values of the direct current when the L values are decreased by 30% as compared with the initial values (the measured value of Isat−30%). It can be judged that the higher this value is, the more the inductance value can be held to a large current (in other words, the performance is excellent). Further, the measurements of the DC superimposition characteristics are performed in the same manner as the embodiments 1-20 and the comparative examples 1-7. According to the results shown in FIG. 8, it is understood that excellent DC superimposition characteristics can be obtained when the number of the core pieces is four or more and particularly excellent DC superimposition characteristics can be obtained when the number of the core pieces is eight or more. Further, it is understood that extremely excellent DC superimposition characteristics can be obtained when the number of the core pieces is ten or more. FIG. 10 is a graph that shows plotting of the DC superimposition characteristics of these embodiments and examples. In FIG. 10, the horizontal axis corresponds to the number of the core pieces and the vertical axis corresponds to the DC superimposition characteristics. According to FIG. 10, it is also understood that excellent DC superimposition characteristics can be obtained when the number of the core pieces is four or more and particularly excellent DC superimposition characteristics can be obtained when the number of the core pieces is eight or more. In particular, it is understood that the DC superimposition characteristic tends to saturate when the number of the core pieces is ten or more. In other words, it is specifically preferred that the number of the core pieces is ten or more. Further, the values of the DC superimposition characteristics shown in FIG. 8 are obtained by rounding off beyond the first decimal place. FIG. 10 is the graph that shows the plotting of the values before rounding off.

### Embodiments 29-64 and Comparative Examples 10-19

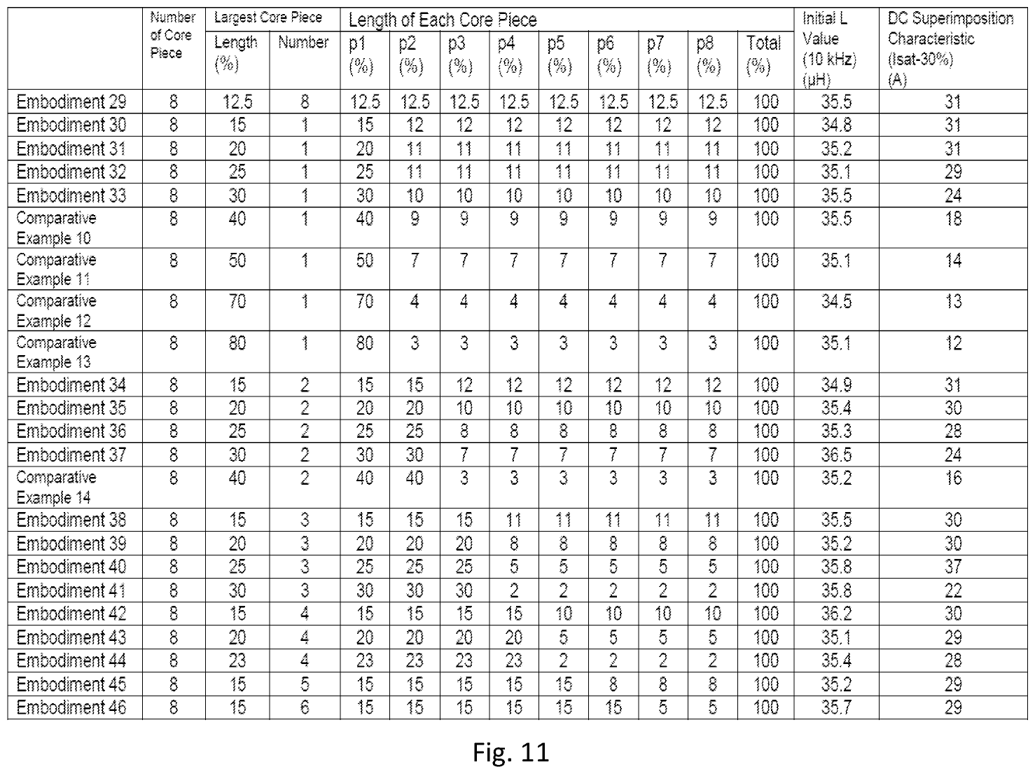

Next, embodiments 29-64 and comparative examples 10-19 will be explained with reference to FIGS. 11-15. In these embodiments and examples, the annular shape is also utilized for each of the coil component cores. In these embodiments and examples, the parameters of the coil component cores are also shown in FIG. 4. However, all of the heights (the thicknesses) h are 5 mm.

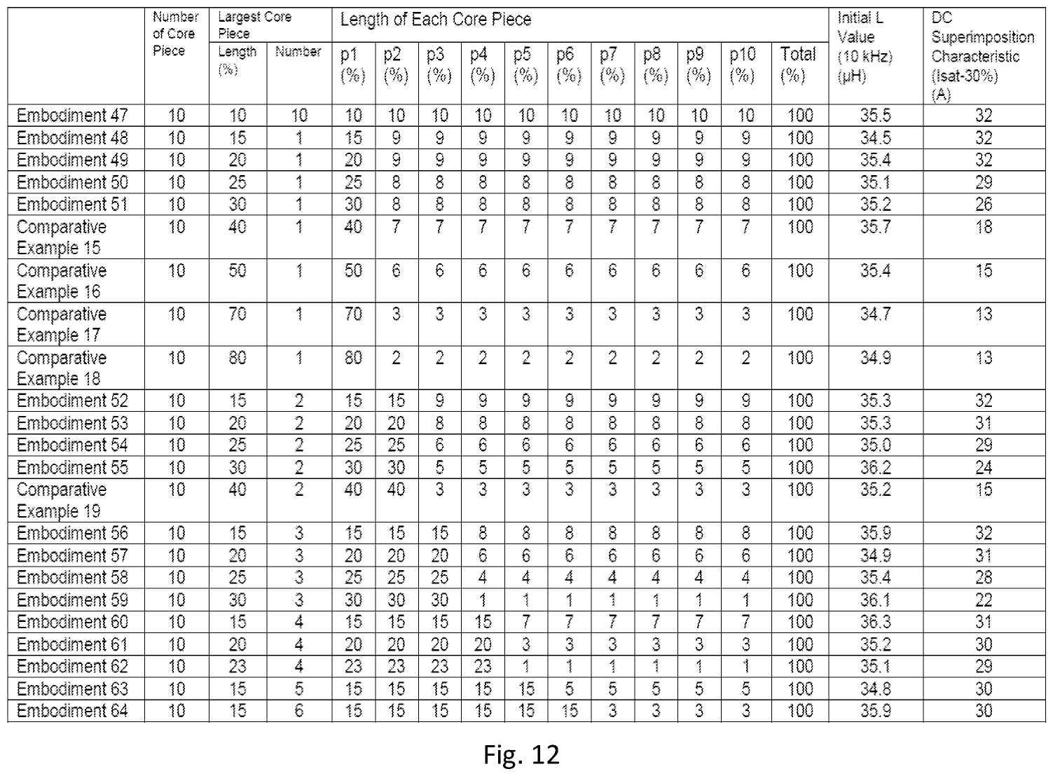

As shown in FIG. 11, with respect to all of the embodiments 29-46 and the comparative examples 10-14, the number of the core pieces (a core piece number) is eight. As shown in FIG. 12, with respect to all of the embodiments 47-64 and the comparative examples 15-19, the number of the core pieces (a core piece number) is ten. Each of the core pieces is arc-shaped. Further, with respect to each of the coil component cores, the sizes of the gap dimensions of the plurality of non-magnetic gaps are the same.

In the embodiment 29, the lengths I of each of the core pieces are equal. On the other hand, with respect to the embodiments 30-46 and the comparative examples 10-14, a part (parts) of the lengths I of each of the core pieces is different from the lengths I of the other core pieces. Further, with respect to the embodiment 47, the lengths I of each of the core pieces are equal. On the other hand, with respect to the embodiments 48-64 and the comparative examples 15-19, a part (parts) of the lengths I of each of the core pieces is different from the lengths I of the other core pieces.

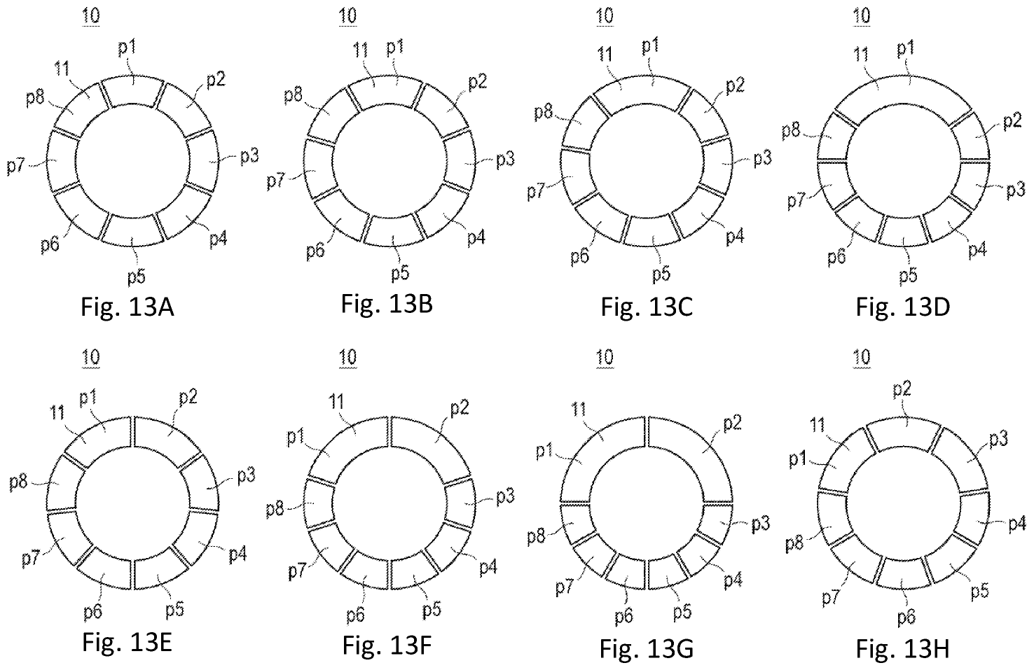

FIGS. 13A-13H show shapes of the coil component cores with respect to part the embodiments 29-46.

For instance, FIG. 13A shows the shape of the coil component core according to the embodiment 29 in which the lengths I of each of the core pieces are equal. Here, with respect to each of the core pieces, the reference numerals of p1, p2, p3, p4, p5, p6, p7, and p8 are marked clockwise. These reference numerals also correspond to the descriptions shown in FIG. 11. As explained above, because the lengths I of each of the core pieces are equal in the embodiment 29, as shown in FIG. 11, a ratio of the length of each of the core pieces p1-p8 with respect to the length of the magnetic path of the coil component core is respectively 100/8=12.5%. Further, the ratio of the length of each of the core pieces p1-p8 shown in FIG. 11 corresponds to the ratio of the length including the gap dimension of the non-magnetic gap.

FIG. 13B shows the shape of the coil component core of the embodiment 30. As shown in FIG. 11, in the embodiment 30, with respect to only the core piece p1, the ratio of the length to the magnetic path of the coil component core is 15%. With respect to the other core pieces p2-p8, the ratios of each of the lengths to the magnetic path of the coil component core are respectively 12%. Here, “a largest core piece” shown in FIG. 11 means the core piece in which the ratio of the length to the magnetic path of the coil component core is the largest among the core pieces p1-p8. For instance, only the core piece p1 is the largest core in the embodiment 30. Therefore, in FIG. 11, it is described that “the number” of “the largest core piece” is one and “the length” of “the largest core piece” is 15% with respect to the embodiment 30.

FIG. 13C shows the shape of the coil component core of the embodiment 31. As shown in FIG. 11, in the embodiment 31, with respect to only the core piece p1, the ratio of the length to the magnetic path of the coil component core is 20%. With respect to the other core pieces p2-p8, the ratios of each of the lengths to the magnetic path of the coil component cores are respectively 11%. As shown in FIG. 11, “the number” of “the largest core piece” is one and “the length” of “the largest core piece” is 20% with respect to the embodiment 31.

FIG. 13D shows the shape of the coil component core of the embodiment 32. As shown in FIG. 11, in the embodiment 32, with respect to only the core piece p1, the ratio of the length to the magnetic path of the coil component core is 25%. With respect to the other core pieces p2-p8, the ratios of each of the lengths to the magnetic path of the coil component cores are respectively 11%. As shown in FIG. 11, “the number” of “the largest core piece” is one and “the length” of “the largest core piece” is 25% with respect to the embodiment 32.

FIG. 13E shows the shape of the coil component core of the embodiment 34. As shown in FIG. 11, in the embodiment 34, with respect to only the core pieces p1 and p2, the ratios of each of the lengths to the magnetic path of the coil component core are respectively 15%. With respect to the other core pieces p3-p8, the ratios of each of the lengths to the magnetic path of the coil component cores are respectively 12%. As shown in FIG. 11, “the number” of “the largest core piece” is two and “the length” of “the largest core piece” is 15% with respect to the embodiment 34.

FIG. 13F shows the shape of the coil component core of the embodiment 35. As shown in FIG. 11, in the embodiment 35, with respect to only the core pieces p1 and p2, the ratios of each of the lengths to the magnetic path of the coil component core are respectively 20%. With respect to the other core pieces p3-p8, the ratios of each of the lengths to the magnetic path of the coil component cores are respectively 10%. As shown in FIG. 11, “the number” of “the largest core piece” is two and “the length” of “the largest core piece” is 20% with respect to the embodiment 35.

FIG. 13G shows the shape of the coil component core of the embodiment 36. As shown in FIG. 11, in the embodiment 36, with respect to only the core pieces p1 and p2, the ratios of each of the lengths to the magnetic path of the coil component core are respectively 25%. With respect to the other core pieces p3-p8, the ratios of each of the lengths to the magnetic path of the coil component cores are respectively 8%. As shown in FIG. 11, “the number” of “the largest core piece” is two and “the length” of “the largest core piece” is 25% with respect to the embodiment 36.

FIG. 13H shows the shape of the coil component core of the embodiment 38. As shown in FIG. 11, in the embodiment 38, with respect to only the core pieces p1, P2, and p3, the ratios of each of the lengths to the magnetic path of the coil component core are respectively 15%. With respect to the other core pieces p4-p8, the ratios of each of the lengths to the magnetic path of the coil component cores are respectively 11%. As shown in FIG. 11, “the number” of “the largest core piece” is three and “the length” of “the largest core piece” is 15% with respect to the embodiment 38.

Further, with respect to the other embodiments and comparative examples, the lengths of each of the core pieces p1-p8, and the numbers and the lengths of the largest core pieces are also respectively shown in FIG. 11. Further, the coil component cores according to each embodiment and comparative example shown in FIG. 12 respectively have ten of the core pieces p1-p10. With respect to these embodiments and comparative examples, the length of each of the core pieces p1-p8, and the numbers and the lengths of the largest core pieces are also respectively shown in FIG. 12. Further, with respect to any of the embodiments and examples, when a plurality of largest core pieces exists, each core piece is arranged so that these largest core pieces are adjacent to each other in the magnetic path direction (the largest core pieces are collectively arranged in the magnetic path direction).

With respect to the embodiments 29-64 and comparative examples 10-19, the coil is also provided by winding a coated lead wire in which a wire diameter is 0.9 mm around the coil component core 50 times so as to configure the coil component. Thereafter, the coil component is inserted into a case in which two external electrodes are formed. Further, two terminals of the coil are respectively soldered to the external electrodes so as to manufacture the inductor. Since the effective relative magnetic permeability of the coil component core is adjusted to be 40, as shown in FIGS. 11 and 12, initial inductance values (initial L values) are supposed to become the same at any of the inductors. However, in the embodiments and examples, because the coil component cores 10 having the same height (5 mm) have the different numbers of core pieces 11 (the different numbers of the non-magnetic gaps 15), the actual initial L value (initial inductance values) of some of the coil component cores 10 having the same height are slightly different. In addition, since all of the number of turns of the wire that configures the coil are the same (the 50 times), the DC resistance values of each inductor become the same. Further, the measurement of the initial L values are performed in the same manner as the embodiments 1-20 and the comparative examples 1-7.

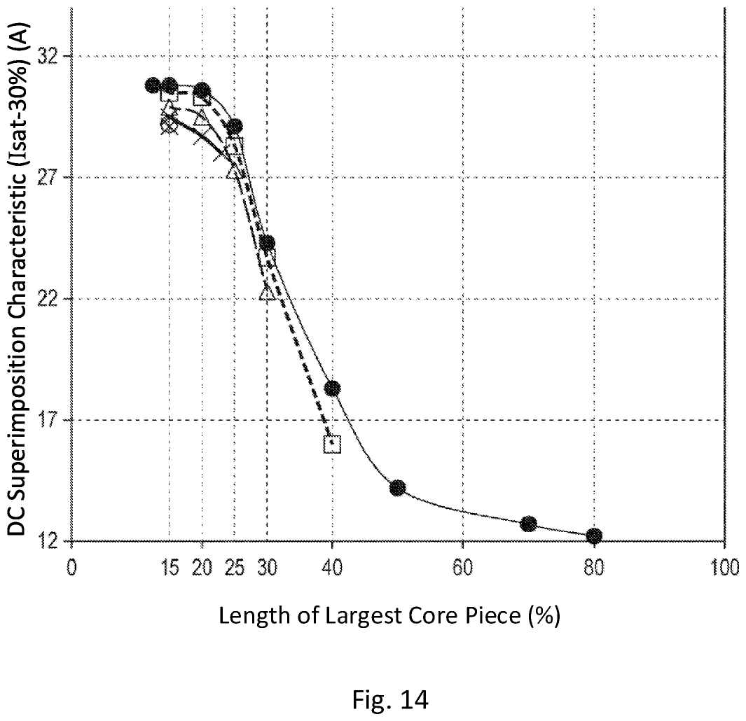

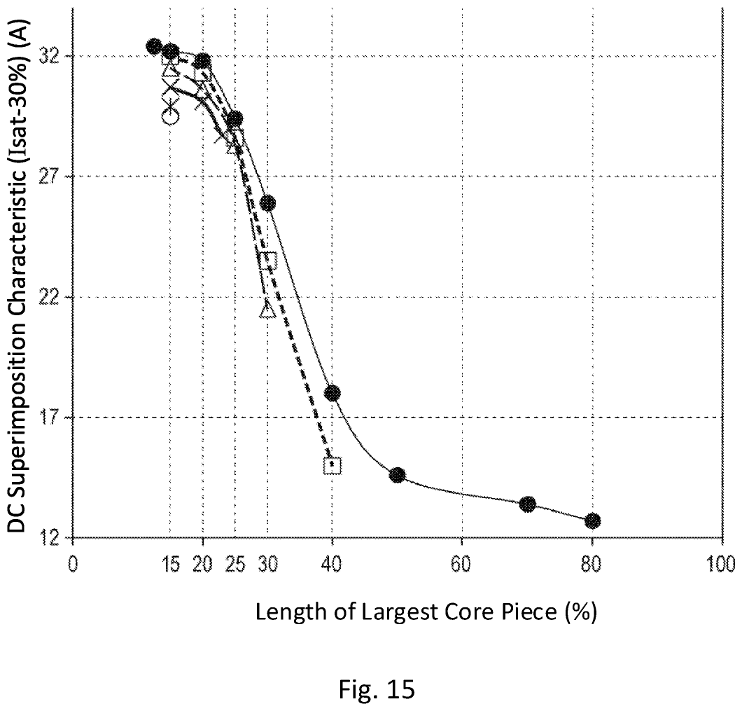

The measured values of the DC superimposition characteristics are shown in FIGS. 11 and 12 with respect to the embodiments 29-64 and the comparative examples 10-19. In these embodiments and examples, the DC superimposition characteristics also correspond to the values of the direct current when the L values are decreased by 30% as compared with the initial values (the measured value of Isat−30%). It can be judged that the higher this value is, the more the inductance value can be held to a large current (in other words, the performance is excellent). Further, the measurements of the DC superimposition characteristics are performed in the same manner as the embodiments 1-20 and the comparative examples 1-7. According to the results shown in FIGS. 11 and 12, when the number of the core pieces that configure the coil component core is eight or more, it is understood that when the length I of the core piece that is the largest among the plurality of the core pieces that configures the coil component core is equal to or less than 30% of the length of the magnetic path of the coil component core, the excellent DC superimposition characteristic can be obtained. That is, when the number of the core pieces that configure the coil component core is eight or more, since the length of the largest core piece is equal to or less than 30% of the length of the magnetic path of the coil component core, excellent DC superimposition characteristics can be obtained. Further, it is understood that more excellent DC superimposition characteristics can be obtained when the length of the largest core piece is equal to or less than 25% of the length of the magnetic path of the coil component core. Further excellent DC superimposition characteristics can be obtained when the length of the largest core piece is equal to or less than 20% of the length of the magnetic path of the coil component core. Particularly excellent DC superimposition characteristics can be obtained when the length of the largest core piece is equal to or less than 15% of the length of the magnetic path of the coil component core. FIG. 14 is a graph that shows plotting of the DC superimposition characteristics of the embodiments and the comparative examples shown in FIG. 11. FIG. 15 is a graph that shows plotting of the DC superimposition characteristics of the embodiments and the comparative examples shown in FIG. 12. In each of FIGS. 14 and 15, the horizontal axis corresponds to the lengths of the largest core pieces and the vertical axis corresponds to the DC superimposition characteristics. According to FIGS. 14 and 15, it is also understood that when the number of the core pieces that configure the coil component core is eight or more, excellent DC superimposition characteristics can be obtained when the length of the largest core piece is equal to or less than 30% of the length of the magnetic path of the coil component core. Further, it is understood that more excellent DC superimposition characteristics can be obtained when the length of the largest core piece is equal to or less than 25% of the length of the magnetic path of the coil component core. Further excellent DC superimposition characteristics can be obtained when the length of the largest core piece is equal to or less than 20% of the length of the magnetic path of the coil component core. Particularly excellent DC superimposition characteristics can be obtained when the length of the largest core piece is equal to or less than 15% of the length of the magnetic path of the coil component core. Further, the values of the DC superimposition characteristics shown in FIGS. 11 and 12 are obtained by rounding off beyond the first decimal place. FIGS. 14 and 15 show plotting of the values before rounding off.

The coil component core and the coil component being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims. Further, the above embodiments can be combined with each other and such combinations are not to be regarded as a departure from the spirit and scope of the invention.

The embodiments include the following technical ideas:

(1) A coil component core is configured by having a plurality of core pieces that are connected in an annular shape, with respect to each of the plurality of core pierces, when a length in a magnetic path direction is I and a cross-sectional area that is perpendicular to the magnetic path direction is S, I/S is equal to or less than 1.0.
(2) In the coil component core according to (1), with respect to each of the plurality of core pieces, I/S is equal to or less than 0.8.
(3) In the coil component core according to (1) or (2), the number of the core pierces is equal to or more than 8.
(4) In the coil component core according to (1) or (2), the number of the core pierces is equal to or more than 10.
(5) In the coil component core according to any one of (1)-(4), with respect to each of the plurality of core pieces, I is equal to or less than 25% of a magnetic path length of the coil component core.
(6) In the coil component core according to any one of (1)-(4), with respect to each of the plurality of core pieces, I is equal to or less than 20% of a magnetic path length of the coil component core.
(7) In the coil component core according to (3) or (4), with respect to each of the plurality of core pieces, I is equal to or less than 30% of a magnetic path length of the coil component core.
(8) A coil component includes the coil component core according to any one of (1)-(7) and a coil that is wound around the coil component core.

What is claimed is:

1. A coil component core comprising:
a plurality of core pieces connected in an annular shape,
wherein, with respect to each of the plurality of core pierces, when a length in a magnetic path direction is I and a cross-sectional area that is perpendicular to the magnetic path direction is S, I/S is equal to or less than 1.0.

2. The coil component core according to claim 1,
wherein the I/S is equal to or less than 0.8.

3. The coil component core according to claim 1,
wherein a number of the core pierces is equal to or more than 8.

4. The coil component core according to claim 2,
wherein a number of the core pierces is equal to or more than 8.

5. The coil component core according to claim 1,
wherein a number of the core pierces is equal to or more than 10.

6. The coil component core according to claim 2,
wherein a number of the core pierces is equal to or more than 10.

7. The coil component core according to claim 1,
wherein, with respect to each of the plurality of core pieces, the I is equal to or less than 25% of a magnetic path length of the coil component core.

8. The coil component core according to claim 2,
wherein, with respect to each of the plurality of core pieces, the I is equal to or less than 25% of a magnetic path length of the coil component core.

9. The coil component core according to claim 3,
wherein, with respect to each of the plurality of core pieces, the I is equal to or less than 25% of a magnetic path length of the coil component core.

10. The coil component core according to claim 1,
wherein, with respect to each of the plurality of core pieces, the I is equal to or less than 20% of a magnetic path length of the coil component core.

11. The coil component core according to claim 2,
wherein, with respect to each of the plurality of core pieces, the I is equal to or less than 20% of a magnetic path length of the coil component core.

12. The coil component core according to claim 3,
wherein, with respect to each of the plurality of core pieces, the I is equal to or less than 20% of a magnetic path length of the coil component core.

13. The coil component core according to claim 1,
wherein, with respect to each of the plurality of core pieces, the I is equal to or less than 30% of a magnetic path length of the coil component core.

14. The coil component core according to claim 2,
wherein, with respect to each of the plurality of core pieces, the I is equal to or less than 30% of a magnetic path length of the coil component core.

15. The coil component core according to claim 3,
wherein, with respect to each of the plurality of core pieces, the I is equal to or less than 30% of a magnetic path length of the coil component core.

16. A coil component comprising:
a coil component core having a plurality of core pieces connected in an annular shape; and
a coil that is wound around the coil component core,
wherein, with respect to each of the plurality of core pierces, when a length in a magnetic path direction is I and a cross-sectional area that is perpendicular to the magnetic path direction is S, I/S is equal to or less than 1.0.

17. The coil component according to claim 16,
wherein the I/S is equal to or less than 0.8.

18. The coil component according to claim 16,
wherein a number of the core pierces is equal to or more than 8.

19. The coil component according to claim 16,
wherein a number of the core pierces is equal to or more than 10.

20. The coil component according to claim 16,
wherein, with respect to each of the plurality of core pieces, the I is equal to or less than 25% of a magnetic path length of the coil component core.
